(19) United States
(12) Patent Application Publication
(10) Pub. No.: US 2022/0034178 A1
(43) Pub. Date: Feb. 3, 2022

(54) System and Method for Treating Drill Cuttings

(71) Applicant: Vincent Joseph HUGHES, Lubbock, TX (US)

(72) Inventor: Vincent Joseph HUGHES, Lubbock, TX (US)

(21) Appl. No.: 17/389,218

(22) Filed: Jul. 29, 2021

Related U.S. Application Data
(60) Provisional application No. 63/058,406, filed on Jul. 29, 2020.

(51) Int. Cl. E21B 21/06; E21B 21/01; B07B 1/36

(52) U.S. Cl. CPC E21B 21/066; B07B 1/36; E21B 21/01

(57) ABSTRACT

A system for recycling drilling fluid. The system has a washer coupled to a drilling rig. The washer receives drill cuttings with entrained drilling fluid. The drilling fluid has a base, and the washing fluid has the same base fluid. The washer fluid is used to remove drilling fluid from the drill cuttings. The washed drill cuttings are sent to a shaker to separate the solids. The spent washing fluid is sent to a filter which separates solids and recovers the base fluid. The base fluid can then be used for drilling or washing.

### PRIORITY

The present invention claims priority to U.S. Provisional Application No. 63/058,406 filed Jul. 29, 2020, the entirety of which are incorporated by reference.

### BACKGROUND OF THE INVENTION

### Technical Field

The present invention relates to a system and method for treating drill cuttings.

### Description of Related Art

Drilling fluid, also referred to as “mud”, is used in drilling operations. Spent drill cuttings, which includes used mud, is returned to the surface during drilling. It is desirable to recover as much mud as possible from the drill cuttings.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a block of a system for treating drill cuttings in one embodiment;

FIG. 2 is a schematic of a washer in one embodiment;

FIG. 3 is a perspective view of a filter in one embodiment;

FIG. 4 is a perspective view of a shaker in one embodiment;

FIG. 5 is a perspective view of a solids conveyor in one embodiment.

FIG. 6 is a perspective view of a skid in one embodiment.

FIG. 7 is a top view of a skid in one embodiment.

### DETAILED DESCRIPTION

Several embodiments of Applicant's invention will now be described with reference to the drawings. Unless otherwise noted, like elements will be identified by identical numbers throughout all figures. The invention illustratively disclosed herein suitably may be practiced in the absence of any element which is not specifically disclosed herein.

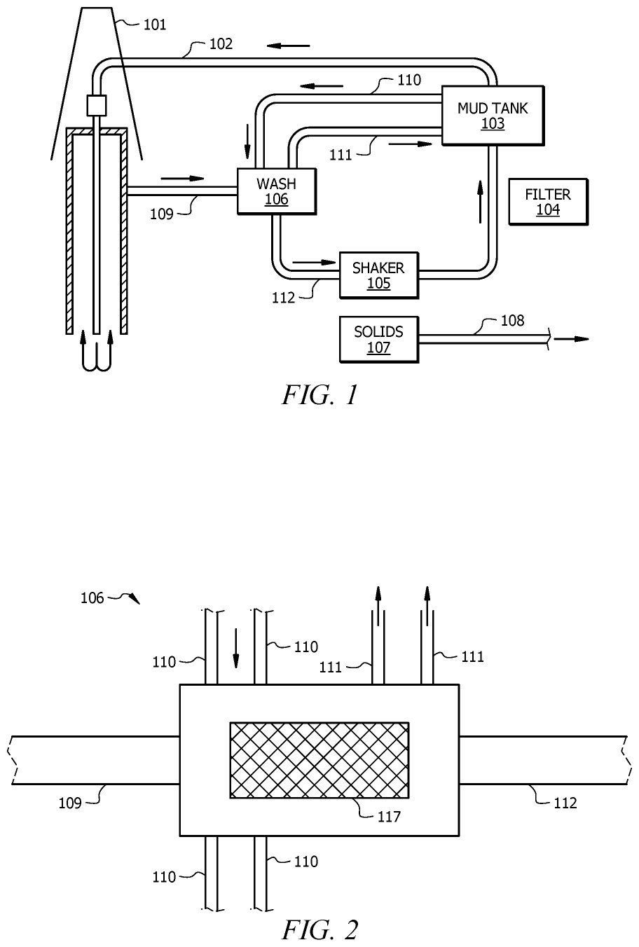

FIG. 1 is a block of a system for treating drill cuttings in one embodiment. Drilling fluid, or mud, is used in a drilling rig 101 for a variety of purposes. The drilling fluid is used to cool the drill bit as well as remove debris and other solids which are dislodged by the drill bit. Drilling fluid is introduced downhole via a drilling supply line 102. Spent drilling fluid, cuttings, and solids, are returned via the drilling return line 109.

The drilling return line 109 brings drill cuttings, spent drilling fluid, and other debris from the drilling rig 101. If the spent drilling fluid can be sufficiently cleaned by removing solids and the drill cuttings, the drilling fluid can be reused.

The drilling return line 109 is in fluid communication with a washer 106. The washer 106 washes the drill cuttings. The drill cuttings have drilling fluid all around and entrained in the cuttings. Thus, the washer 106 removes as much of the drilling fluid as possible for subsequent reuse.

In one embodiment the drilling fluid has a base fluid. The base fluid can be water, oil, etc. In one embodiment the same base fluid used in the drilling fluid is used in the washing. In other embodiments the same drilling fluid is used to wash the drill cuttings. Put differently, the same drilling fluid which is directed downhole is used to wash the drill cuttings. This has several benefits. First, this reduces the footprint of the system as the same mud used for drilling can be used for cleaning as well.

Second, it reduces the need for a separate stream which must be, at some point, discarded. Elimination of a separate stream not only helps environmentally, but also decreases the need for equipment such as tanks and pumps which will house and move the stream.

Third, by using the same base drilling fluid, only one stream needs to be cleaned to be recycled and reused.

As noted, the same base fluid is used in the washer 106. This allows drilling fluid which is entrained or captured by the drill cuttings to be released. This increases the recapture efficiency of the drilling fluid and results in increased yield.

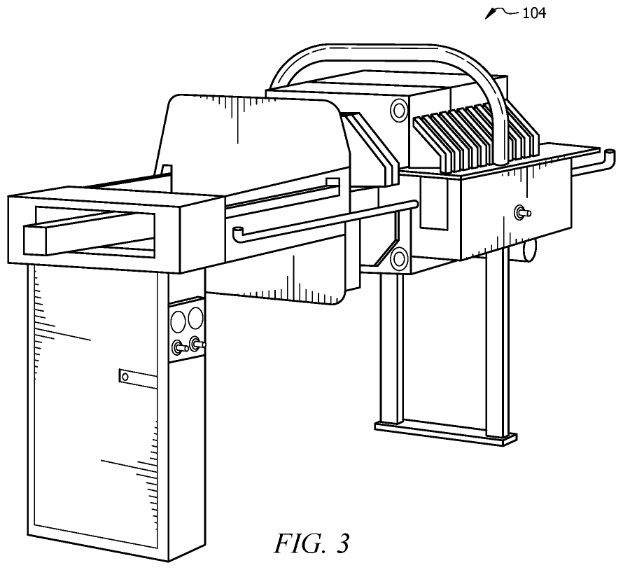

Turning briefly to FIG. 2, FIG. 2 is a schematic of a washer in one embodiment. As shown the drilling return line 109 brings drill cuttings to the washer 106. The drill cuttings are sprayed with the base fluid in the wash supply line 110. The wash supply line 110 supplies base fluid from either the mud tank 103, or another base fluid tank. While FIG. 1 shows the wash supply line 110 as a single line, that line can be broken into multiple inlet lines, as shown in FIG. 2. Breaking the supply line 110 into multiple smaller inlets increases the surface area and helps remove entrapped or entrained drilling fluid from the drill cuttings.

The washer 106 exposes the drill cuttings to the base fluid with the goal of removing drilling fluid from the drill cuttings. Accordingly, the wash return 111 returns retrieved base fluid. The wash return 111 can have screens or filters to ensure only fluid, without large solids, is returned. While FIG. 2 shows the wash return lines 111, in other embodiments the washer will have small holes which allow the drilling fluid to pass. The base fluid is then collected and routed to the desired location.

While FIG. 1 shows that the wash return line 111 is directed to the mud tank 103, this is for illustrative purposes only and should not be deemed limiting. The wash return 111 can, in certain embodiments, be routed to the mud tank 103. This will depend upon a variety of factors including volume, size and type of the filter in the washer 106, if any, etc. In other embodiments, however, the wash return 111 is routed to the filter 104 before being routed to the mud tank 103.

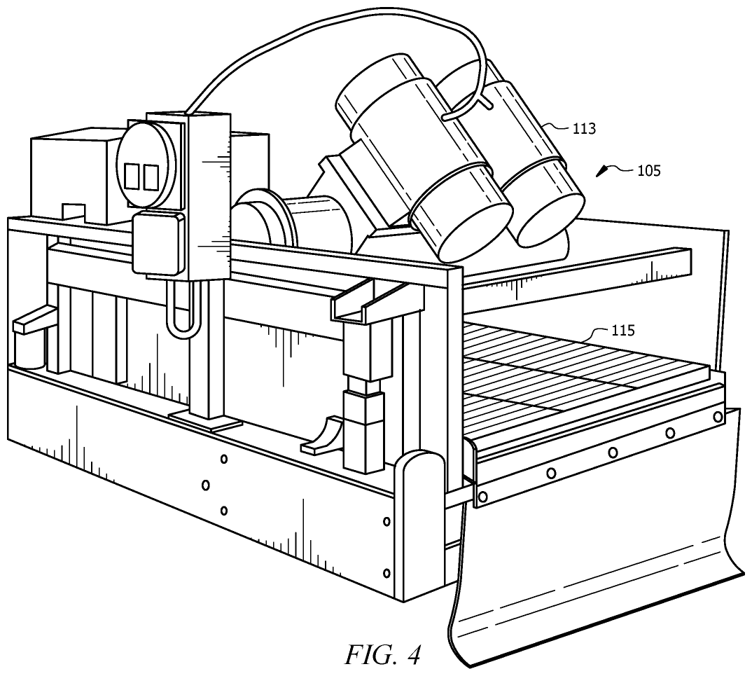

Turning to FIG. 3, FIG. 3 is a perspective view of a filter in one embodiment. As depicted, the filter 104 is a press filter wherein liquid is injected so as to pass through a filtrate. Solids entrained in the filter are trapped by the filtrate. The fluid leaving the filter 104 is free of solids of the specified size.

While a press filter has been shown, this is for illustrative purposes and should not be deemed limiting. Other types of filters, including mechanical and non-mechanical filters can be utilized. These can include membrane filters, gravity filters, etc.

As noted, while the filter 104 is depicted, in FIG. 1, as being located between the shaker 105 and the mud tank 103, this is for illustrative purposes only and should not be deemed limiting. The system can comprise one or more filters 104 located in various locations throughout the system. As an example, the filter 104 can be located downstream of the washer 106 between the washer 106 and the mud tank 104. In other embodiments, the same filter 104 is used to filter fluid retrieved from the shaker 105 and the washer 106.

As shown, after fluid is recovered from the solids, it is then cycled with the filter 104. Thus, rather than simply recovering fluid, the system treats the fluid and that fluid is returned to the system is base fluid once again. In one embodiment wherein the filter is a filter press, the filter 104 starts at 5 microns and as the successive plates fill the micron size goes down. This is better than centrifuge systems which in practice are limited to above 10 microns. Thus, the filter 104 provides equipment which will be able to remove the low gravity solids (do we have a definition for low gravity solids) without sending the fluid to a separate plant. This results in drastic savings on fluid over the course of several wells.

The fluid that is recovered from the solids will be a base fluid and will be able to be used as dilution, saving on the operator's dilution costs.

Note, in some embodiments wherein the filter 104 is a filter press, the filter press may not completely replace the need for a centrifuge. However, it will be able to eliminate the need for more than one, saving substantial costs for many uses who use two or more.

In one operation of a filter press, the press only requires air and is fed with an electric pump. When the pressure gets to a specified level, which in some embodiments is 90 PSI, the pump shuts off and the operator is alerted. The operator will then open the plates and the solids will fall into an open top of a hopper.

The clean fluid from the filter 104 will be deposited into the clean side of the tank and will be used again in the washing process or returned to the pit as dilution.

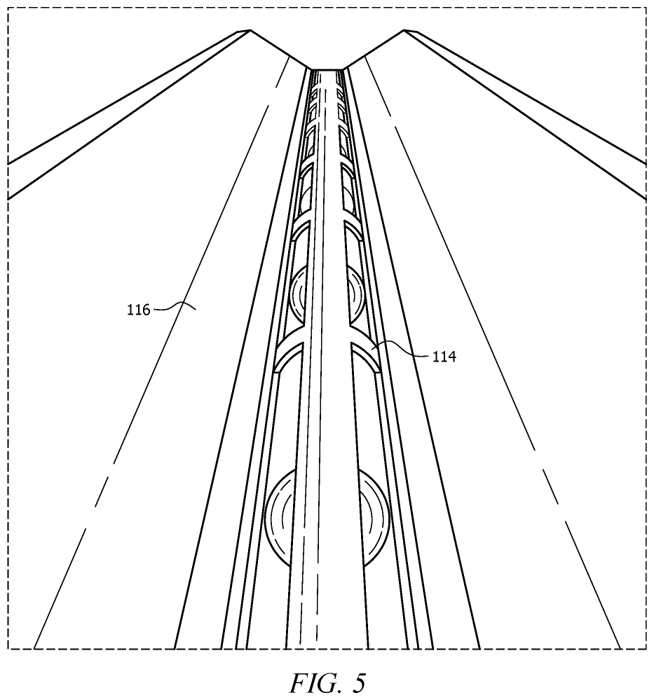

Returning to FIG. 1, the shaker supply line 112 directs the washed drill cuttings to the shaker 105. In one embodiment, the shaker supply line 112 is a pumpable slurry. The shaker supply line 112 can supply the shaker 105 with drill cuttings via any transport method or device known in the art. In one embodiment a tubular drag chain conveyor 114 (as shown in FIG. 5) is utilized. In one embodiment the tubular drag chain conveyor 114 is built into a trough that is utilized to gather and transport the solids to the shaker 105 and blower.

While a tubular drag chain conveyor 114 is discussed, other conveyors and tools to move product can be utilized. FIG. 5 is a perspective view of a solids conveyor in one embodiment. As depicted in FIG. 5, a tubular drag chain conveyor 114 is utilized. In one embodiment utilizing a drag chain conveyor 114, the conveyor is a continuous loop. Thus, the loop continuously receives and deposits material. In one embodiment the conveyor 114 is designed to transport 1.5 cubic yards of material per minute. As seen, the conveyor 114 is located at the bottom of a trough 116. As depicted, the trough 116 is a V-shaped trough which directs material to the conveyor. The trough 116 is designed to capture the solids from the shakers 105 and feed them to the drag chain conveyor 114 while protecting the drag chain 114 from large objects.

The drag chain conveyor 114 can be powered and controlled via any method or device known in the art. In one embodiment the drag chain conveyor 114 is VFD driven allowing the user to control the speed, reverse the conveyor 114 in the event of a jam. Further, in one embodiment the conveyor 114 is equipped with an electronic shear pin to prevent damage in the event of a jam.

The conveyor 114 can comprise virtually any material. In one embodiment the chain is carbon steel and is equipped with rotating pins which allow the chain to bend in multiple directions. This allows for greater reliability and gentleness on the material being transported. The discs in the drive component can likewise comprise a variety of materials. In one embodiment the discs comprise high quality polyurethane and are easily rotated and changed as they wear.

It should be noted that while FIG. 1 shows a separate washer 106, this is for illustrative purposes and should not be deemed limiting. In other embodiments the washer 106 is inline with the drag chain conveyor 114. Thus, as the solids are being transported via the conveyor 114, they are washed with the wash fluid, which may be the base fluid. As an example, if OBM is being utilized then diesel will be used to wash the solids. Once washed, the washed solids are deposited onto the shaker 105.

In one embodiment the washing has two steps. The first step is in the trough 116 where fluid is pumped into the conveyor 114 and fills up the trough 116. This ensures the solids are surrounded by wash fluid. The solids are then transported through the clean fluid and are pulled through the steam of fluid in the trough 116. The solids and wash fluid combination is then directed to a washer 106, as shown in FIG. 2. In one embodiment the washer 106 comprises a screen 117 which allows fluid to exist the washer 106. In one embodiment fluid exits the screen 117 directly into mud tank 103, which is subsequently cleaned by filter 104. The solids remaining continue to the shaker 105.

As can be seen, the “washer” 106 can have a variety of features. The washing can take place in the trough, in a separate washer, in a pipe with a screen 117, etc.

The shaker 105, in one embodiment, uses vibration to further separate the drilling fluid from the solids. FIG. 4 is a perspective view of a shaker 105 in one embodiment.

The shaker 105, in one embodiment, uses a shaker screen 115 to further separate the solids from the liquids. The shaker screen 115 vibrates to further enhance the separation. In one embodiment the shaker screen 115 also acts as a conveyor so it conveys product from the upstream end to the downstream end. The drill cuttings get dryer as they move from the upstream end to the downstream end of the shaker 105.

The size of the holes in the shaker screen 115 can vary depending upon the application. The liquid will fall through the screen 115 while the larger solids remain on the screen.

In one embodiment the shaker 105 further has one or more blowers 113. These blowers 113 take air and force air upon the drill cuttings. This results in increased separation of the liquid drilling fluid from the solid drill cuttings. In one embodiment the shaker 105 further comprises an air knife to further aid in the fluid recovery process.

The liquid collected from the shaker 105 is then directed either to the mud tank 103 or the filter 104 for further processing. In one embodiment, the solids retrieved from the shaker 105 are then conveyed to a storage hopper where they are subsequently remotely stored or discarded. The mud tank 103 can comprise virtually any storage tank of any desired size. In one embodiment the mud tank 103 comprises a 25 BBL tank which is used to recover fluid which has been used in the washing of the solids. The fluid, in some embodiments, is then cleaned with a filter 104, and then recycled as wash fluid and dilution for the drilling fluid.

The solids exiting the shaker 105 have had the vast majority of any drilling fluid removed therefrom. This is a benefit for several reasons. First, the solids exiting the shaker 105 generally must be housed, transported, and discarded. Reducing the weight of these solids decreases the cost in storing, transporting, and discarding. Second, maximizing the amount of drilling fluid recovered from the solids minimizes the amount which is ultimately discarded. Even if the improvement results in 2% by weight of the drill cuttings being recovered and reused, that decreases the waste stream by 2%. This is a significant reduction in the discarded waste. Further, whatever drilling fluid which is recovered from the drill cuttings is later reused. This further decreases the amount of new materials which are utilized in the drilling.

The solids leaving the shaker 105 can be conveyed via any conveyor or transporting equipment known in the art. In one embodiment the system utilizes a drag chain conveyor as shown in FIG. 5. As depicted, the solids conveyor is a drag chain conveyor. The drag chain conveyor uses a drag chain 114 to catch and hold material during transport.

While the solids conveyor shown in FIG. 5 can be used to convey the solids from the shaker, the solids conveyor can also be used to transport drill cuttings from the rig 101 to the shaker 105. In one embodiment, the solids conveyor, such as a drag chain depicted in FIG. 5, is used as a washer. Base fluid, as previously described, is introduced into the drag chain to remove any entrained drilling fluid/base fluid located on or within the drill cuttings.

FIG. 1 shows a mud tank 103. The mud tank 103 is a storage tank which houses clean drilling fluid/base fluid. The mud tank 103 can comprise virtually any storage tank known in the art. As noted, the mud tank 103 can be fluidly coupled to the drilling rig 101 to direct clean mud to the rig 101. The drilling fluid retrieved from the wash 106, the shaker 105, and the filter 104 are deposited into the mud tank 103. As noted, one or more filters 104 can be used prior to sending the drilling fluid to the mud tank 103. In other embodiments, the mud tank 103 is circulated through a filter 104 to continuously removed solids. In other embodiments there is a filter 104 between the mud tank 103 and the drilling rig 101. The point is that there can be a plurality of filters 104 located throughout the system to fill various needs.

In one embodiment, the mud tank 103, filter 104, shaker 105, and wash 106 are all located on a single skid. This is a benefit in that it ensures that the system is moveable along traditional rail and roadways. This allows the system to be moved and installed in locations adjacent to a drilling rig 101.

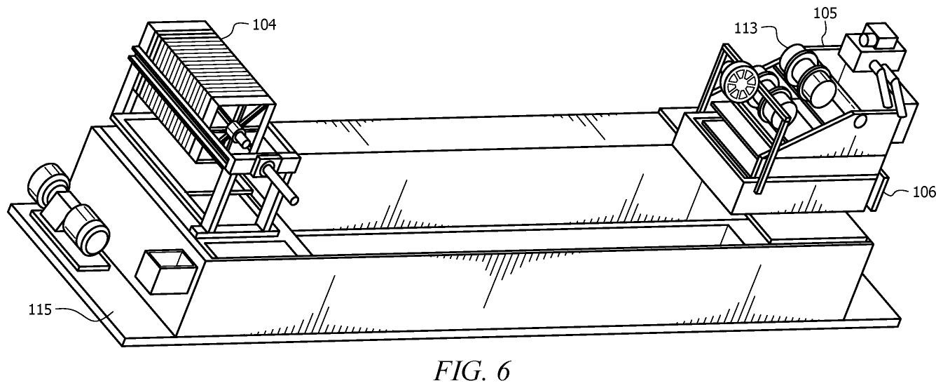

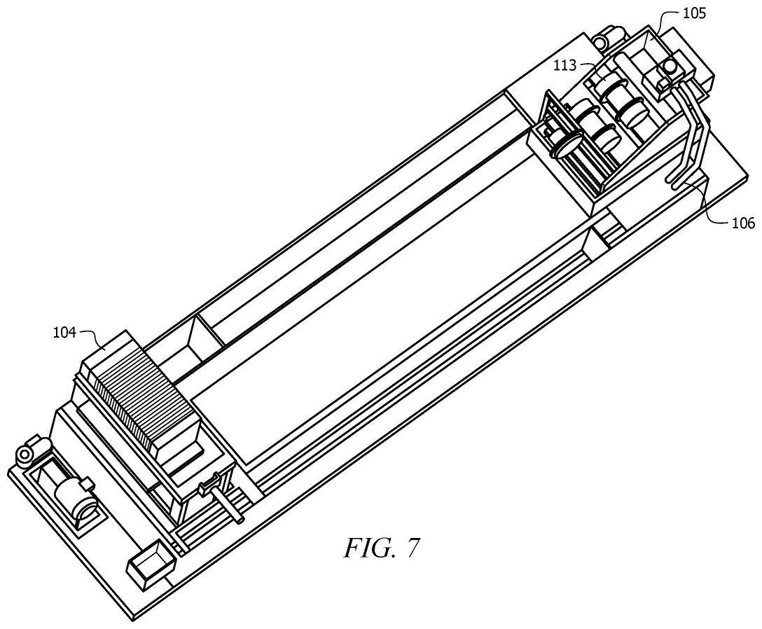

FIG. 6 is a perspective view of a skid in one embodiment. FIG. 7 is a top view of a skid in one embodiment. As shown the shaker 105, filter 104, and the wash 106 are located on a skid 115. The mud tank 103 can be located under the shaker 105 or under the filter 104. On FIG. 7, the lower part of the figure shows the drag chain conveyor. As noted, the washing can take place in the drag chain conveyor.

As noted, the clean fluid recovered from the filter 104 can be deposited into the clean side of the tank and then be used again in the washing process or be returned to the pit system as dilution. In one embodiment the mud tank 103 comprises a single tank with a baffle to separate the clean side from the dirty side. Clean fluid from the filter 104 is fed to the clean side. Dirty fluid recovered from the washer or shaker is collected in the dirty side. In one embodiment dirty fluid is collected and then deposited into the dirty side. In another embodiment the dirty side is located below the shaker so dirty fluid falls into the dirty side. In another embodiment the dirty side is located below the washer to dirty fluid falls into the dirty side.

One benefit is that the system has a low footprint. Often space along and adjacent a drilling rig 101 is at a premium. Land is used to house various storage tanks, water, tools, etc. Thus, having a system on a single skid which provides for the treatment of drilling fluid is an advantage. The system replaces three pieces of equipment.

Another advantage is that being on a skid the system is transportable to other job locations. The drilling rig 101, once drilled, may not require additional drilling fluid. The system can then be transported to a new drilling rig 101 which is drilling, and which requires drilling fluid. In one embodiment the system is a stand-alone unit which makes it ideal for stretch or walking rigs.

The greatest benefit, perhaps, is the potential to eliminate ever needing to send fluid in for reconditioning. This lowers the cost of fluid, the cost of operation, etc. It further decreases the dilution costs. Further, it reduces solid disposal costs as it works efficiently in all fluid types and formations.

The benefits of the system discussed herein are highlighted when compared to other prior art systems. In one embodiment the system described herein delivers a 3-7% better ROC (Retention On Cuttings) than prior art drying shakers. The fluid recovered, as noted, is ready to be used as dilution and is LGS free. This eliminates having to send the fluid in for treatment. C centrifuge will remove the bar and good chemicals, it will not get down to the LGS which is detrimental to the fluid. The system described herein is efficient and will remove the bar and good chemicals but will further remove the LGS.

Other prior art methods use a centrifuge or other system to reduce LGS. However, such systems can only get to the 10-12 microns. The system discussed herein, in one embodiment, gets the fluid down to below 2 microns. Fluid with above 10 microns is unusable. Instead, the user must either dilute the stream or send it for processing. Conversely, fluid with 2 microns or below can be used immediately without dilution and without sending the fluid for outside processing.

While a centrifuge might be needed for other fluid purposes, a centrifuge is not necessary for the fluid filtration as that is accomplished with a filter, such as a filter press instead. This eliminates the need for the capital cost of the additional centrifuge as well as the footprint required for the operation of the additional centrifuge.

The consumable costs of the system is lower than the drying shaker as there is only 1 shaker which requires screens. The only other consumables involved are the cloths for the filter press which are estimated to be only about $4 k per quarter. There are additional cost savings as the system is three pieces of equipment in one, replacing the drying shakers, open top, and centrifuge.

While Vertical Dryers may have a similar ROC, vertical dryers are temperamental and only achieve best results under optimum conditions. The system discussed herein, however, performs consistently and uniformly throughout all formations and types of fluids being used. Further, the system is easier to operate than a vertical dryer. Finally, the fluid recovered in the vertical dryer is laden with LGS after the solids have been processed through the dryer. This fluid will need to be ran through a centrifuge to have the solids removed whereas the fluids recovered with the instant system can used as dilution immediately. Thus the cost savings on fluid costs alone are substantial.

When compared to cuttings grinder, the system discussed herein offers 1-3% better ROC. The cutting grinder has fluid which is very high in LGS. The pump and the grinder demolish the solids in the fluid creating excessive amounts of LGS. The LGS is so high that it cannot be completely removed by a centrifuge.

While a system has been described, a method utilizing the system will now be described. First drill cuttings are received. The drill cuttings are washed in a washer 106. In one embodiment the same base fluid which is used in the drilling fluid is used to clean the drill cuttings. In other embodiments the same drilling fluid which is used to drill is used is used to clean the drill cuttings. In some embodiments the same drilling fluid is used to both drill and clean the drill cuttings.

The washed drill cuttings are conveyed to a shaker 105. The shaker 105 further separates solids from liquid. In one embodiment the shaker 105 uses a shaker screen 115 and a blower 113 to further separate the solids from the liquids.

The solids are conveyed to a storage tank or other vessel. In one embodiment, the solids are conveyed via a drag chain.

The liquids exiting the shaker 105 are directed to a filter 104. The filter 105 removes additional solids from the liquid. The cleaned fluid is directed to a mud tank 103.

In some embodiments the mud tank 103 circulates its contents with a filter 104. As noted, in some embodiments the shaker 105, washer 106, mud tank 103, and filter 104 are housed on a single skid.

While the invention has been particularly shown and described with reference to a preferred embodiment, it will be understood by those skilled in the art that various changes in form and detail may be made therein without departing from the spirit and scope of the invention.

What is claimed is:

1. A system for recycling drilling fluid, said system comprising:
a washer coupled to a drilling rig, wherein said washer receives drill cuttings and a washer fluid, and wherein said drill cuttings comprise entrained drilling fluid;
wherein said drilling fluid comprises a base fluid, and wherein said washer fluid uses said base fluid to clean said drill cuttings;
a shaker whereby washed drill cuttings are placed upon said shaker to separate solids;
a filter which further separates solids and recovers base fluid;
a mud tank which houses base fluid.

2. The system of claim 1 further comprising a conveyor to convey drill cuttings.

3. The system of claim 2 wherein said conveyor comprises a tubular drag chain conveyor.

4. The system of claim 3 wherein said tubular drag chain conveyor is coupled to a trough, and wherein said trough catches solids from said shaker.

5. The system of claim 3 wherein said tubular drag chain is coupled to a trough, and wherein said trough is pumped with washer fluid to clean said drill cuttings.

6. The system of claim 5 wherein said tubular drag chain is coupled to a pipe which comprises a screen to allow washer fluid to pass.

7. The system of claim 2 wherein said tubular drag chain conveyor comprises an endless loop.

8. The system of claim 1 wherein said filter is a filter press.

9. The system of claim 1 wherein said shaker comprises a blower.

10. The system of claim 1 wherein said shaker comprises an air knife.

11. The system of claim 3 wherein said tubular drag chain conveyor moves 1.5

12. A method of cleaning drill cuttings, said method comprising the steps of:
a) receiving drill cuttings which have drilling fluid, wherein said drilling fluid comprises a base fluid;
b) washing said drill cuttings with the same base fluid to produce washed solids;
c) depositing said washed solids into a shaker;
d) separating solids from liquids in said shaker.

13. The method of claim 12 wherein said washing comprises conveying said drill cuttings with a tubular drag chain conveyor and submerging said drill cuttings with said base fluid.

14. The method of claim 12 wherein said separating comprises blowing said washed solids with a blower.

15. The method of claim 12 wherein said tubular drag chain is coupled to a trough.

16. The method of claim 12 further comprising the step of e) recovering liquids from said shaker, and f) filtering said liquids.

17. The method of claim 16 wherein said filtering comprises utilizing a filter press.

18. The method of claim 17 wherein said filtering does not require the use of a centrifuge.
